(19) United States
(12) Patent Application Publication
(10) Pub. No.: US 2024/0378197 A1
(43) Pub. Date: Nov. 14, 2024

(54) QUERY TRANSLATION FOR DATABASES STORING SEMANTIC DATA

(71) Applicant: Microsoft Technology Licensing, LLC, Redmond, WA (US)

(72) Inventors: Kameswara Venkatesh EMANI, Madison, WI (US); Avrilia Floratou, Sunnyvale, CA (US); Carlo Aldo Curino, Woodinville, WA (US); Philip John Seamark, Upper Hunt (NZ); Xinyu Liu, Cumming, GA (US); Joyce Cahoon, Woodinville, WA (US); Ashvin Agrawal, Cupertino, CA (US)

(21) Appl. No.: 18/316,912

(22) Filed: May 12, 2023

(51) Int. Cl. G06F 16/2452; G06F 16/242; G06F 16/2453

(52) U.S. Cl. CPC G06F 16/24522; G06F 16/2433; G06F 16/24544

(57) ABSTRACT

Described are examples for querying a database that stores semantic data in a compressed linked tabular representation. An ordered list of relational operators can be extracted from a language-agnostic representation of a query for semantic data from the database. The language-agnostic representation of the query can be translated, based on the ordered list of relational operators, into a database query of a query language syntax that is supported by the database, and the database query can be executed on the database without decompressing the data stored in the compressed linked tabular representation.

### BACKGROUND

Data scientists and data engineers spend a significantly large portion of time trying to understand, clean and transform data before performing any meaningful data analysis. Some companies have developed business intelligence tools provide an efficient and user-friendly platform for customers to perform data cleaning, preparation, and linking tasks to obtain actionable semantic data. These tools can simplify data preparation by providing users with a visual interface, such as a drag and drop interface, which may also have optional textual querying capabilities, to perform operations on the data. The operations may include filtering, projections, joins, sorting, grouping, aggregation, plotting, and others.

In some systems, the prepared datasets are stored in a compressed linked tabular representation where relationships between various tables are stored into the representation. This can simplify querying for users as the query need not specify which tables to join in each query, rather the data processing engine can leverage the semantic information present in the underlying representation to automatically join the datasets appropriately and efficiently. The operations specified using the tools can be translated into query language syntax supported by the database that stores the data representations. Some examples of such languages can include data analysis expressions (DAX), multidimensional expressions (MDX), etc. The DAX/MDX queries can be executing on the database using a SQL Server Analysis Services (SSAS) engine. In some examples, the data representations can be stored in the database in a compressed columnar format, and the SSAS engine can include techniques to directly perform query operations on the compressed columnar formatted data without first decompressing the data, which can result in orders of magnitude improvements in query performance.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a device for querying a database that stores semantic data in a compressed linked tabular representation is provided that includes a memory storing instructions, and a processor coupled to the memory. The processor is configured to execute the instructions to convert an initial language query for semantic data in the database to a language-agnostic representation of the initial language query, generate, based on a nested structure of the language-agnostic representation, an ordered list of relational operators, translate, based on the ordered list of relational operators, the language-agnostic representation into a database query of a query language syntax that is supported by the database.

In another example, a computer-implemented method for querying a database that stores semantic data in a compressed linked tabular representation is provided that includes extracting, from a language-agnostic representation of a query for semantic data from the database, an ordered list of relational operators, translating, based on the ordered list of relational operators, the language-agnostic representation of the query into a database query of a query language syntax that is supported by the database, and executing the database query on the database without decompressing the compressed linked tabular representation.

In another example, a non-transitory computer-readable device storing instructions thereon that, when executed by a computing device, cause the computing device to query a database that stores semantic data in a compressed linked tabular representation is provided. The instructions include instructions for extracting, from a language-agnostic representation of a query for semantic data from the database, an ordered list of relational operators, translating, based on the ordered list of relational operators, the language-agnostic representation of the query into a database query of a query language syntax that is supported by the database, and executing the database query on the database without decompressing the compressed linked tabular representation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for translating a query for a database that stores semantic data, in accordance with aspects described herein.

FIG. 2 is a flow diagram of an example of a method for translating a language-agnostic query into a query language syntax supported for querying a database with semantic data, in accordance with aspects described herein.

FIG. 3 illustrates an example of an initial language query and a language-agnostic representation of the query, in accordance with aspects described herein.

FIG. 4 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to translating a query from one syntax to a different syntax supported by a database that stores semantic data and/or executing the translated query on the database to provide query results. For example, the database can store the data as semantic data based on representations generated from the data that are stored in a linked tabular representation. Semantic data can refer to data in different tables or other constructs having a semantic relationship (e.g., a same value for a similar column. The database can automatically associate this data having the semantic relationship by a join operation to join or otherwise link the tables or other constructs based on having the same value for the similar column.

In addition, for example, the database can store linked tabular data in a compressed columnar format to facilitate efficient query operations without necessarily decompressing the data. The database can support the query operations using a certain query language syntax, such as data analysis expression (DAX), multidimensional expression (MDX), etc., which may not be easily understood by a user. In an example, the database system can generate the DAX/MDX query based on a visual representation of the query provided using a visual interface. Aspects described herein relate to translating a language-agnostic query for data in the database into the query language syntax supported by the database to facilitate querying the semantic data. For example, other query languages, such as structured query language (SQL), imperative programming languages, such as Python, natural language (NL), etc., can be converted to the language-agnostic format, and then translated into a query of the query language syntax supported by the database.

In an example, translating the language-agnostic query can include generating an ordered list of relational operators from the language-agnostic query, and translating each relational operator into a portion of the database query that is in the query language syntax. For example, the translation operation may start with translating an innermost (or first) relational operator to a first portion of the database query, and can continue to translate each relational operator until an outermost (or last) relational operator is translated. In addition, in some examples, optimizations can be applied in one or more of the translation operations. In addition, in an example, the conversion of the initial query from SQL, imperative programming language, NL, etc. to the language-agnostic query can be performed using a process with protocol buffers for serializing query plans. In any case, for example, the translation operation can understand the syntax of the language-agnostic query and can generate the database query based on the serialized query plan, using the above translation operation.

Translating queries in this regard can allow users to specify queries for semantic data in the database using SQL, imperative programming languages, NL, etc., instead of having to use DAX, MDX, or other languages supported by the database. As a result, the customer or users can experience the benefits of using business intelligence tools to create representations of data in compressed linked tabular representations, including data preparation, cleaning, linking, etc., query efficiency, and/or the like, with also having the ability to draft and execute queries in a more readily-available or well-known query or programming language (or NL). In addition, customers may not need to move data out of the database into another database to execute these other types of queries (e.g., SQL, imperative programming languages, NL, etc.), as the query translation allows for executing these queries in the language syntax supported by the database.

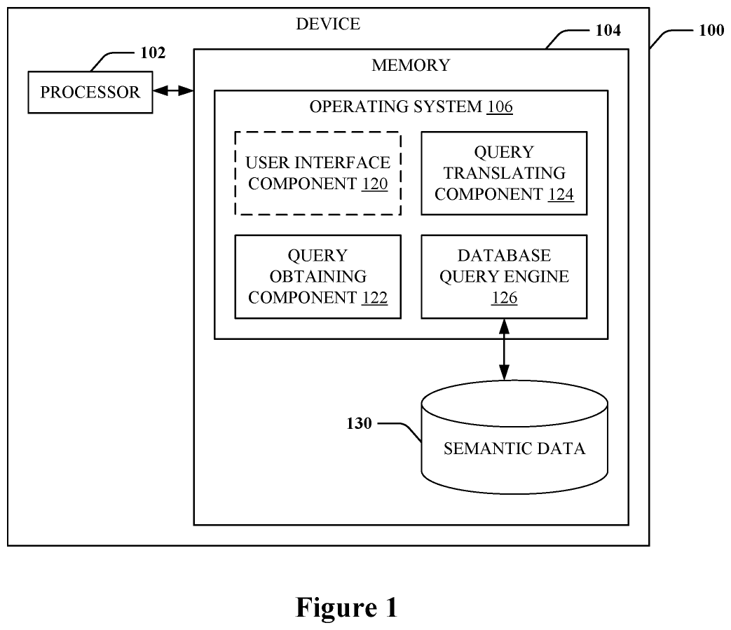

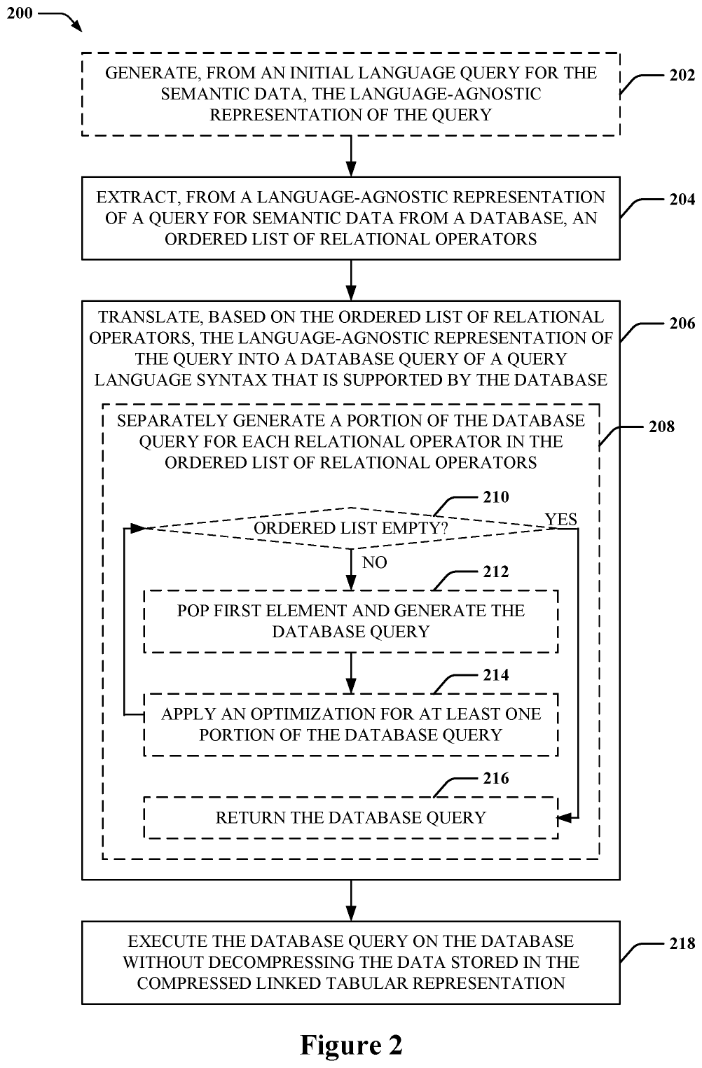

Turning now to FIGS. 1-4, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) for translating a query for a database that stores semantic data. In an example, device 100 can include a processor 102 and/or memory 104 configured to execute or store instructions or other parameters related to providing an operating system 106. which can execute one or more applications or processes. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein.

Device 100 can also include a database 130 that stores semantic data, which can include compressed linked tabular representations of data that can have specified relationships between various tables of the data. For example, the database 130 can be provided by, or modified by, business intelligence tools to include various representations of the data in various tables, such as the compressed linked tabular representations. The database 130 can store the linked tabular data using a compressed columnar format.

In one example, the operating system 106 can execute one or more applications or processes, such as, but not limited to, an optional user interface component 120 for defining a query for semantic data using SQL, an imperative programming language, NL, or other syntax that is not supported by the database 130, a query obtaining component 122 for obtaining or generating a language-agnostic query for semantic data in the database 130, a query translating component 124 for translating the language-agnostic query into a query language syntax supported for querying the database 130, and/or a database query engine 126 for querying the database 130 by processing queries specified in the query language syntax. For example, database query engine 126 can process DAX or MDX queries for querying the database 130, including performing the query operations without decompressing the semantic data in database 130.

In an example, query obtaining component 122 can obtain the language-agnostic query from memory 104 or other data store or can generate the language-agnostic query from a query of a different query language, such as SQL, an imperative programming language, such as Python, NL, etc. For example, query obtaining component 122 can extract, from the language-agnostic query, a list of multiple ordered relational operators, which can be ordered based on a hierarchical position of the relational operator within a nested structure of the language-agnostic query (e.g., starting with an innermost relational operator and working out to an outermost relational operator). In an example, query translating component 124 can generate the database query, which is of the query language syntax supported by the database query engine 126 for querying the database 130, at least in part by translating each relational operator in the list and according to the order of the relational operators in the list. For example, query translating component 124 can translate each relational operator to generate a portion of the database query. In another example, query translating component 124 can perform an optimization for a given one of the relational operators in generating the respective portion of the database query.

FIG. 2 is a flowchart of an example of a method 200 for translating a language-agnostic query into a query language syntax supported for querying a database with semantic data. For example, method 200 can be performed by a device 100 or other device, and/or one or more components thereof, to facilitate translating queries for databases with semantic data.

In method 200, optionally at action 202, a language-agnostic representation of a query can be generated from an initial language query for semantic data. In an example, query obtaining component 122, e.g., in conjunction with processor 102, memory 104, operating system 106, etc., can generate, from the initial language query for the semantic data, the language-agnostic representation of the query. In an example, query obtaining component 122 can retrieve the language-agnostic representation of the query from memory 104 or can generate the language-agnostic representation of the query based on the initial language query. For example, the initial language query can include one or more of a SQL query, a query in an imperative programming language, such as Python, a natural language query, etc. In one example, user interface component 120 can provide a user interface that can allow a user to input the initial language query as the SQL query, imperative programming language query, natural language query, etc.

In an example, query obtaining component 122 can generate the language-agnostic query from the initial language query by a process that generates a standard representation for query plans, such as by using protocol buffers for serializing query plans. For example, query obtaining component 122 can generate, from the initial language query, a query plan that is nested starting with a root operator including operands, which in turn include other operators and associated operands and so on. For example, the language-agnostic representation can include a common query plan that can be generated from the initial language query.

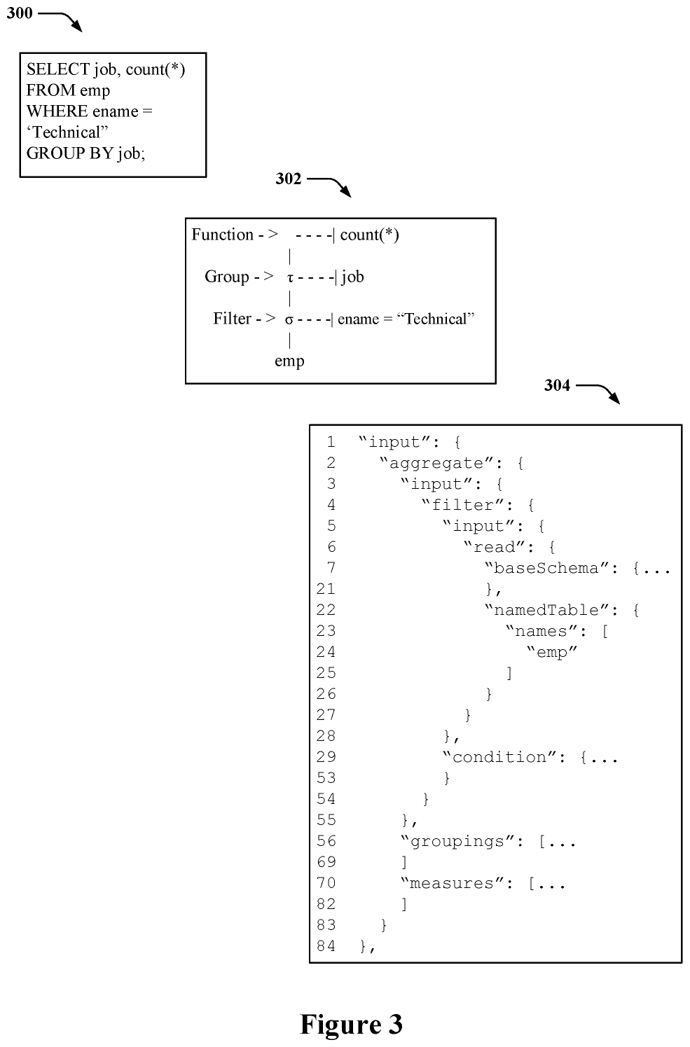

In one example, query obtaining component 122 can use a specification for representing data operations, such as Substrait, to generate the language-agnostic representation of the initial language query. In general, Substrait can interface with various standard query languages, such as SQL, Python, NL, etc., and can generate a common query plan regardless of the original query language used to define the query. For example, Substrait can provide relational built-in support for relational algebraic operations (e.g., select, project, join, aggregation, group by, order by, etc.) and common types (e.g., int, float, string, etc.) with an extension framework that enables representation of user defined functions and custom operators. Substrait can facilitate communicating the query plan between a query parser and a query execution engine. Substrait can use protocol buffers for serializing query plans, where protocol buffers can be a highly efficient binary format for transmitting data over a network. An example is shown in FIG. 3.

FIG. 3 illustrates an example of an initial language query 300 and a language-agnostic representation 304 of the query. For example, given the initial language query 300, query obtaining component 122 can generate the language-agnostic representation 304, which can be a representation of the query plan generated using Substrait or a similar specification that starts with a root operator and operands and generates additional operators and associated operands. For example, for initial language query 300, a query plan 302 is shown that separates the query into a function (count) for a group (job) based on a filter (ename=“Technical”) for the emp table. In this example, query obtaining component 122 can convert query plan 302 into language-agnostic representation 304, which can be represented as a JavaScript Object Notation (JSON) listing of operations, which can be nested.

In one specific example, query obtaining component 122 can generate the language-agnostic representation of the query from an imperative programming language, such as Python, where a program listing in the imperative programming language may include a series of operations (e.g., join operations) for tables before executing a query on the joined table. In an example, a library, such as Ibis, can be used to generate the language-agnostic representation of the query (e.g., the Substrait common query plan) as a nested query plan, as described above, from the series of operations in the imperative programming language (e.g., Python) or SQL representation. For example, the root operator or operands of the series of operations can be identified in the Substrait representation, and the language-agnostic representation can be in the nested format starting with the root operator or operands. Generating the language-agnostic representation in this regard can allow for further optimization of the query plan, as described herein (e.g., in conjunction with action 214).

In another specific example, query obtaining component 122 can generate the language-agnostic representation of the query from NL or other languages (e.g., Pandas) by converting the NL (or Pandas) representation of the query to an imperative programming language representation of the query, such as Python. In this example, query obtaining component 122 can then generate the language-agnostic representation of the query from the Python representation, as described above. For NL, in an example, query obtaining component 122 may also translate from NL to Pandas using an artificial intelligence (AI) or machine learning (ML) technique based on large language models, such as ChatGPT. In this example, query obtaining component 122 can then translate from Pandas to Ibis and then to Substrait, as described above.

In method 200, at action 204, an ordered list of relational operators can be extracted from a language-agnostic representation of a query for semantic data from a database can be generated. In an example, query translating component 124, e.g., in conjunction with processor 102, memory 104, operating system 106, etc., can extract, from the language-agnostic representation of the query for semantic data from the database, the ordered list of relational operators. For example, the query can include the initial language query, as described above, from which the language-agnostic representation is generated. In an example, query translating component 124 can generate the ordered list of relational operators based on a hierarchical or nesting level of the relational operators, such that an innermost relational operator is first in the ordered list, at least for a first sequence of relational operators at a root level in the serialized query plan. For example, query translating component 124 can generate the ordered list of relational operators first hierarchically and then serially as the operators are listed in the language-agnostic representation. In an example, query translating component 124 can use a parser to identify the ordered list of relational operators and/or corresponding properties, attributes, etc. from the language-agnostic representation of the query.

For example, referring to the language-agnostic representation 304 in FIG. 3, query translating component 124 can generate the ordered list of relational operators having the “read” operator on line 6 first, the “filter” operator on line 4 next, and the “aggregate” operator on line 2 last. For example, the “read” operator on line 6 can be an innermost operator in the language-agnostic representation within the hierarchy of operators shown, and thus precedes the “filter” operator and the “aggregate” operator in the ordered list of relational operators. Similarly, for example, the “filter” operator on line 4 can be an next innermost operator in the language-agnostic representation within the hierarchy of operators shown, and thus precedes the “aggregate” operator in the ordered list of relational operators.

In method 200, at action 206, the language-agnostic representation of the query can be translated, based on the ordered list of relational operators, into a database query of a query language syntax that is supported by the database. In an example, query translating component 124, e.g., in conjunction with processor 102, memory 104, operating system 106, etc., can translate, based on the ordered list of relational operators, the language-agnostic representation of the query into the database query of the query language syntax that is supported by the database. For example, the query language syntax can include DAX, MDX, or other query language that can be used to query the data in in the database 130 that is of the compressed columnar format without decompressing the data. In an example, query translating component 124 can map detected relational operators in the list to corresponding query language commands (e.g., in DAX, MDX, etc.), and can generate the query to include the mapped commands and an indication of its associated properties or attributes, which can have been identified by the parser, as described above.

In translating the language-agnostic representation of the query at action 206, optionally at action 208, a portion of the database query can be separately generated for each relational operator in the ordered list of relational operators. In an example, query translating component 124, e.g., in conjunction with processor 102, memory 104, operating system 106, etc., can separately generate the portion of the database query for each relational operator in the ordered list of relational operators. For example, query translating component 124 can generate the portion of the database query starting with a first relational operator in the list and according to the order of the list. In addition, for example, query translating component 124 can generate the portion of the database query starting at an innermost portion of the database query, working outward to an outermost portion of the database query.

In one example, in separately generating portions of the database query at action 208. optionally at action 210, it can be determined whether the ordered list is empty, and if not, optionally at action 212, a first element can be popped from the ordered list and the database query can be generate using the popped first element. In an example, query translating component 124, e.g., in conjunction with processor 102, memory 104, operating system 106, etc., can determine whether the ordered list is empty, and if not, can pop the first element and generate the database query using the first element. For example, query translating component 124 can determine a query statement of the query language syntax that is supported by the database (e.g., a DAX or MDX query statement) that corresponds to the first element popped from the ordered list of relational operators.

Optionally, at action 214, an optimization can be applied for at least one portion of the database query. In an example, query translating component 124, e.g., in conjunction with processor 102, memory 104, operating system 106, etc., can apply an optimization for the at least one portion of the database query (e.g., the portion being generated from the popped ordered list element) in generating the portion of the database query. For example, query translating component 124 can apply optimizations for certain relational operators that may be specific to the query language syntax that is supported by the database (e.g., the query language syntax to which the language-agnostic representation is being translated). In an example, generating the language-agnostic representation of the query plan can facilitate common identification of opportunities for optimizations, and the language-specific optimizations can be applied for the given target query language for the translation. For example, query translating component 124 can determine whether the generated portion of the query matches a certain input pattern, and if so, query translating component 124 can rewrite the query to apply the optimization. In one specific example, query translating component 124 can apply an optimization for a JOIN or GROUPBY operator, by rewriting the portion of the generated database query, which can allow for utilizing optimizations in the query language syntax supported by the database.

In a specific example, DAX or MDX can support a RELATEDTABLE operator that generates a table based on a relation between keys of multiple tables. For example, given an input pattern of:

```
EVALUATE
GENERATE (
  table1,
  FILTER (table2, table1.primary_key = table2.foreign_key)
)
```

query translating component 124 can apply a JOIN optimization to generate a corresponding output:
EVALUATE
GENERATE (table1, RELATEDTABLE (table2))

In another specific example, DAX or MDX can support a SUMMARIZECOLUMNS operator that generates a table that groups records of multiple tables based on column values. For example, given an input pattern of:

```
EVALUATE
SUMMARIZE (
  FILTER (
    GENERATE (
      table1,
      FILTER (table2, table1.primary_key = table2.foreign_key)
    ),
    <condition on table2.column3>
  ),
  table.column1,
  table2.column2,
  <agg_name>, <agg_metric>
)
```

query translating component 124 can apply a GROUPBY optimization to generate a corresponding output:

```
EVALUATE
SUMMARIZECOLUMNS (
  table1.column1,
  table2.column2,
  FILTER (
    ALL (table2.coumn3),
    <condition on table2.column3>
  ),
  <agg_name>, <agg_metric>
}
```

where agg_name is a name for the aggregated column and agg_metric is an aggregate, such as SUM, MAC, etc. that uses a column from table2. Generating the query can persist until the ordered list is empty (e.g., all elements have been popped and corresponding query generation has occurred).

Thus, for example, where it is determined that the ordered list is empty at action 210, optionally at action 216, the database query can be returned. In an example, query translating component 124, e.g., in conjunction with processor 102, memory 104, operating system 106, etc., can return the database query that has been generated.

For example, referring to the language-agnostic representation 304 in FIG. 3, for the “read” operator of lines 6-28, query translating component 124 can generate the portion of the database query to be:
EVALUATE
‘emp’

Then for the “filter” operator of lines 4-53 in the language-agnostic representation 304, query translating component 124 can generate a next outer level portion of the database query, such that the database query can be:
EVALUATE
FILTER (‘emp’, emp[ename]=“Technical”)

Then for the “aggregate” operator of lines 2-8l in the language-agnostic representation 304, query translating component 124 can generate a next outer level portion of the database query, such that the database query can be:

```
EVALUATE
GROUPBY (
  FILTER (‘emp’, emp[ename] = “Technical”)
  emp[job],
  “count”, COUNTX ( CURRENTGROUP ( ), 1)
)
```

In method 200, at action 218, the database query can be executed on the database without decompressing the data stored in the compressed linked tabular representation. In an example, database query engine 126, e.g., in conjunction with processor 102, memory 104, operating system 106, etc., can execute the database query on the database without decompressing the data stored in the compressed linked tabular representation. For example, query translating component 124 can provide the translated query to the database query engine 126 for execution. In an example, database query engine 126 can obtain query results based on executing the database query, and may return the query results. For example, database query engine 126 can return the query results to query translating component 124, which may return the results to query obtaining component 122, user interface component 120, etc., or another component that requested execution of the query, a storage location associated with, or indicated in, the query, and/or the like.

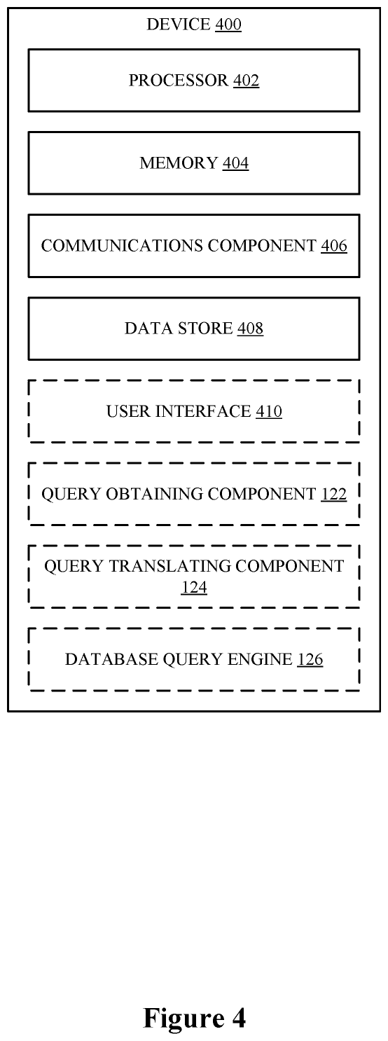

FIG. 4 illustrates an example of device 400 including additional optional component details as those shown in FIG. 1. In one aspect, device 400 may include processor 402, which may be similar to processor 102 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 may further include memory 404, which may be similar to memory 104 such as for storing local versions of operating systems (or components thereof) and/or applications being executed by processor 402, such as a query obtaining component 122, query translating component 124, database query engine 126, one or more components thereof, etc. Memory 404 can include a type of memory usable by a computer, such as random-access memory (RAM), read only memory (ROM), tapes, magnetic discs, optical discs, volatile memory, non-volatile memory, and any combination thereof.

Further, device 400 may include a communications component 406 that provides for establishing and maintaining communications with one or more other devices, parties, entities, etc. utilizing hardware, software, and services as described herein. Communications component 406 may carry communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, which provides for mass storage of information, databases, and programs employed in connection with aspects described herein. For example, data store 408 may be or may include a data repository for operating systems (or components thereof), applications, related parameters, etc.) not currently being executed by processor 402. In addition, data store 408 may be a data repository for a query obtaining component 122, query translating component 124, database query engine 126, one or more components thereof, and/or one or more other components of the device 400.

Device 400 may optionally include a user interface component 410 operable to receive inputs from a user of device 400 and further operable to generate outputs for presentation to the user. User interface component 410 may be similar to, or used to provide, user interface component 120 described above. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A device for querying a database that stores semantic data in a compressed linked tabular representation, comprising:
a memory storing instructions; and
a processor coupled to the memory and configured to execute the instructions to:
convert an initial language query for semantic data in the database to a language-agnostic representation of the initial language query;
generate, based on a nested structure of the language-agnostic representation, an ordered list of relational operators; and
translate, based on the ordered list of relational operators, the language-agnostic representation into a database query of a query language syntax that is supported by the database.

2. The device of claim 1, wherein the processor is configured to execute the instructions to translate the language-agnostic representation into the database query including:
generating an innermost query portion of the database query based on a first operator in the ordered list of relational operators; and
generating a next level query portion of the database query based on a next operator in the ordered list of relational operators.

3. The device of claim 2, wherein the processor is configured to execute the instructions to translate the language-agnostic representation into the database query including separately generating a portion of the database query for each relational operator in the ordered list of relational operators based on a hierarchical position of the relational operator in the nested structure of the language-agnostic representation.

4. The device of claim 3, wherein the processor is configured to execute the instructions to translate the language-agnostic representation into the database query including, for at least one portion of the database query, applying an optimization for the portion of the database query before generating a next portion of the database query.

5. The device of claim 4, wherein the optimization is one of a join optimization or a groupby optimization.

6. The device of claim 1, wherein the processor is configured to execute the instructions to execute the database query on the database without decompressing the compressed linked tabular representation.

7. The device of claim 1, wherein the processor is configured to execute the instructions to generate the language-agnostic representation including using protocol buffers for serializing a query plan represented by the initial language query.

8. The device of claim 1, wherein the initial language query is one of a structured query language (SQL) query, an imperative programming language query, or a natural language query.

9. A computer-implemented method for querying a database that stores semantic data in a compressed linked tabular representation, comprising:
extracting, from a language-agnostic representation of a query for semantic data from the database, an ordered list of relational operators;
translating, based on the ordered list of relational operators, the language-agnostic representation of the query into a database query of a query language syntax that is supported by the database; and
executing the database query on the database without decompressing the compressed linked tabular representation.

10. The computer-implemented method of claim 9, wherein translating the language-agnostic representation of the query into the database query includes:
generating an innermost query portion of the database query based on a first operator in the ordered list of relational operators; and
generating a next level query portion of the database query based on a next operator in the ordered list of relational operators.

11. The computer-implemented method of claim 10, wherein translating the language-agnostic representation of the query into the database query includes separately generating a portion of the database query for each relational operator in the ordered list of relational operators.

12. The computer-implemented method of claim 11, wherein translating the language-agnostic representation of the query into the database query includes, for at least one portion of the database query, applying an optimization for the portion of the database query before generating a next portion of the database query.

13. The computer-implemented method of claim 12, wherein the optimization is one of a join optimization or a groupby optimization.

14. The computer-implemented method of claim 9, further comprising generating, from an initial language query for the semantic data, the language-agnostic representation of the query.

15. The computer-implemented method of claim 14, wherein generating the language-agnostic representation of the query includes using protocol buffers for serializing a query plan represented by the initial language query.

16. The computer-implemented method of claim 14, wherein the initial language query is one of a structured query language (SQL) query, an imperative programming language query, or a natural language query.

17. A non-transitory computer-readable device storing instructions thereon that, when executed by a computing device, cause the computing device to query a database that stores semantic data in a compressed linked tabular representation, the instructions comprising instructions for:
extracting, from a language-agnostic representation of a query for semantic data from the database, an ordered list of relational operators;
translating, based on the ordered list of relational operators, the language-agnostic representation of the query into a database query of a query language syntax that is supported by the database; and
executing the database query on the database without decompressing the compressed linked tabular representation.

18. The non-transitory computer-readable device of claim 17, wherein the instructions for translating the language-agnostic representation of the query into the database query include instructions for:
generating an innermost query portion of the database query based on a first operator in the ordered list of relational operators; and
generating a next level query portion of the database query based on a next operator in the ordered list of relational operators.

19. The non-transitory computer-readable device of claim 18, wherein the instructions for translating the language-agnostic representation of the query into the database query include instructions for separately generating a portion of the database query for each relational operator in the ordered list of relational operators.

20. The non-transitory computer-readable device of claim 19, wherein the instructions for translating the language-agnostic representation of the query into the database query include instructions for, for at least one portion of the database query, applying an optimization for the portion of the database query before generating a next portion of the database query.
